(19) United States
(12) Patent Application Publication
(10) Pub. No.: US 2013/0127718 A1
(43) Pub. Date: May 23, 2013

(54) Method for Operating Computer Objects and Computer Program Product Thereof

(71) Applicants: Po-Tsang Li, Taichung City (TW); Yao-Sheng Yeh, Hsinchu City (TW); Ming-Hsun Chen, Taichung City (TW); Jing-Ru Chiu, Hualien County (TW); Yi-Yuan Li, Zhubei City (TW); Kuan-Chu Hou, Zhubei City (TW); Pei-Zhen Lin, New Taipei City (TW); Wei-Chien Tsai, Miaoli County (TW); Allan Lin, Taipei City (TW); Wen-Lung Tsai, New Taipei City (TW); Chung-Ming Lin, Taoyuan County (TW)

(72) Inventors: Po-Tsang Li, Taichung City (TW); Yao-Sheng Yeh, Hsinchu City (TW); Ming-Hsun Chen, Taichung City (TW); Jing-Ru Chiu, Hualien County (TW); Yi-Yuan Li, Zhubei City (TW); Kuan-Chu Hou, Zhubei City (TW); Pei-Zhen Lin, New Taipei City (TW); Wei-Chien Tsai, Miaoli County (TW); Allan Lin, Taipei City (TW); Wen-Lung Tsai, New Taipei City (TW); Chung-Ming Lin, Taoyuan County (TW)

(73) Assignee: PHIHONG TECHNOLOGY CO.,LTD., Taoyuan County (TW)

(21) Appl. No.: 13/450,304

(22) Filed: Apr. 18, 2012

(30) Foreign Application Priority Data
Nov. 23, 2011 (TW) 100142850

(51) Int. Cl. G09G 5/08; G06F 3/041; G09G 5/00

(52) U.S. Cl. 345/163; 345/156; 345/173

(57) ABSTRACT

A method for operating computer objects and the computer program product thereof are disclosed, and they are utilized to a computer. The computer includes an operating interface which comprises defining a work region, function instruction list and a plurality of computer objects, and parts of the computer objects are chosen. The steps of the method comprises: an input device which is connected to a processing device in the computer for defining the position information of the input device, and a computer object which is chosen on the work region of the operating interface is clicked for operating the computer object; wherein a function instruction, which comprises actions of rotation, zoom in/zoom out, movement, of the computer object, is clicked for users to operate the computer object.

### BACKGROUND

1. Field of Invention

The present invention relates to a method for operating computer objects and the computer program product thereof. More particularly, the present invention relates to a method for operating computer objects of computer program product about graphic software, presentation software or the combination thereof.

2. Description of Related Art

In general, presenters or teachers employed blackboard or whiteboard to write down their points during the meeting or teaching. The listener should take note by hand writing. It is not convenience to the user at all.

Currently, the computer is a typical tool during teachings and meetings for presentation. However, a computer and a projector should be prepared before the teaching or the business presentation, and followed by projecting the information onto the screen. The one who presents the information can write none information on the screen, it is inconvenient to the user. A blackboard or a whiteboard is required to fulfill the requirements for the presentation. The user needs many equipments and the setup of device is complicated and time-consuming.

Therefore, large-size electronic panel devices are development to replace the white board. The computer output the information onto the display of the electronic panel, which is so called the electronic whiteboard. An electronic pen is provided to allow the user to write the text onto the display, even store or print out the text and take note. Some of the electronic panels offer the function to record and display the image file.

However, there are some drawbacks to the electronic panel devices, for instance, the display panel size is limited, and no one can write information outside the screen. The user should erase the former information for writing further information. It is not so convenient. If the presenter or teacher requires opening several files which are different format types at the same time, the user should switch among the files between different computer program products frequently. Further, the current system cannot offer dual way activities between the student and the teacher for the teaching and presentation.

What is required is a more convenient system to improve the foregoing problems.

### SUMMARY

One object of the present invention is to solve the foregoing problems, for example, presenters or teachers should employ a blackboard or a whiteboard to write down their points non-instinctively and non-conveniently during meetings or teachings in prior arts.

In order to reach the foregoing object, the present invention provides a method of operating computer objects which are utilized to an operating interface in a computer, wherein the operating interface comprises defining a work region, at least one function instruction list and a plurality of computer objects, and parts of the computer objects are chosen. The steps of the method comprises: an input device is connected to a processing device in the computer for defining a position information of the input device, and one computer object which is chosen on a work region of the operating interface is clicked for operating the computer object; wherein the function instruction, which comprises actions of rotation, zoom in/zoom out and movement, of the computer object is clicked for users to operate the computer object. Moreover, the computer object which is chosen may be dragged out of the work region for to closing, making miniature or cancelling via the processing device.

In addition, the present invention further provides a method of operating computer objects which are utilized to an operating interface in a computer, wherein the operating interface comprises defining a work region, at least one function instruction list and a plurality of computer objects, and parts is of the computer objects are chosen. The steps of the method comprises: an input device is connected to a processing device in the computer for defining a position information of the input device, and the input device clicks the work region of the operating interface for releasing a chosen state of the computer objects on the work region; and a circumscription in the operating interface is called out and used to choose the computer objects. Thus, the computer objects, which are moved into the circumscription, become a chosen state, and are operated via the function instruction list by the input device. Moreover, the computer objects which are chosen may be dragged out of the work region for closing, making miniature or cancelling via the processing device.

In an embodiment of the present invention, the input device may be a touch panel device, and the step of clicking the work region of the operating interface via the input device may further comprise: all of the computer objects in the work region and the states of the computer objects are listed. Furthermore, the touch panel device may further include: only one touch point, or two touch points. When the touch panel device has at least two touch points, the touch panel device may be operated by a user via gestures. In another embodiment of the present invention, the input device may be a mouse device for a user inputting instructions.

Moreover, the present invention also provides a computer program product for utilizing to graphic and presentation, and the computer program product comprises software code portions for performing the steps of the foregoing method when the product is run on a computer.

Therefore, users may employ the method of operating computer is objects and the computer program product according to the present invention more instinctively in a meeting for presenting or teaching. Furthermore, the computer program product including the foregoing functions also may be used by more variety and interactive effects for the contents of the presentation and teachings.

### BRIEF DESCRIPTION OF THE DRAWINGS

The present description will be better understood from the following detailed description read in light of the accompanying drawings, wherein:

FIG. 1 illustrates a schematic diagram illustrating an embodiment of a system according to the present invention;

FIG. 2 illustrates a flow chart of an embodiment of a method of operating computer objects according to the present invention;

FIGS. 3A-3D illustrate schematic diagrams illustrating an embodiment of a computer program product according to the present invention; and

FIG. 4 illustrates a flow chart of another embodiment of a method of operating computer objects according to the present invention.

### DETAILED DESCRIPTION

The following description includes discussion of figures having illustrations given by way of example of implementations of embodiments of the invention. The drawings should be understood by way of example, and not by is way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

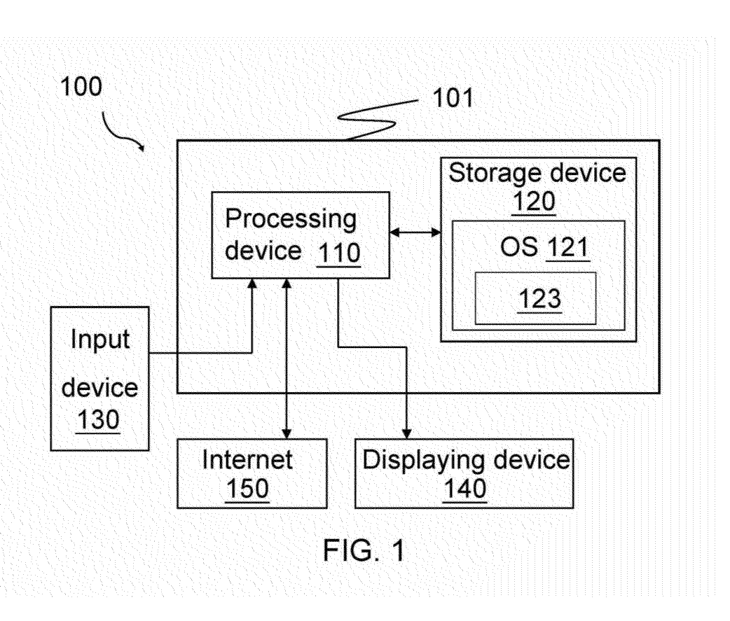

Referring to FIG. 1, it illustrates a schematic diagram illustrating a system according to the present invention. A system 100 is consisted from a computer 101, an input device 130 and a displaying device 140. The computer 101 comprises a processing device 110 and a storage device 120, and the processing device 110 is connected electrically to the storage device 120. In this case, the storage device 120 may stores at least one operating system 121 and a computer program product 123 which is capable to perform a method of operating computer objects according to the present invention. Thus, the processing device 110 may read and execute the operating system 121 and computer program product 123 stored in the storage device 120.

The input device 130 and the displaying device 140 also connect to the processing device 110. The input device 130 is provided users to enter is instructions for operating the computer 101 via the processing device 110, and the displaying device 140 will display the operating interface of the operating system 121 and computer program product 123 for the users.

In an embodiment of the present invention, the input device 130 may be a mouse device, and the displaying device 140 may be a monitor. In another embodiment of the present invention, the input device 130 and the displaying device 140 may be integrated in a touch panel device. Thus, users may touch the touch panel device directly and more instinctively to operate the computer 101. As the other aspects, the touch panel device may further have only one touch point or more than two touch points. When the touch panel device has at least two touch points, the touch panel device may be operated by a user via gestures. However, the input device 130 and the displaying device 140 may be modified or amended by other types of input devices and displaying devices based on the different requirements from users, but there are not limited in the specific embodiments shown in the present document.

Furthermore, the computer 101 may comprise at least one internet 150, and the internet 150 connects electrically to the processing device 110 for transmitting data. In this case, the internet 150 may comprise a wired internet or a wireless internet based on the practice requirements from users, but do not limit in these.

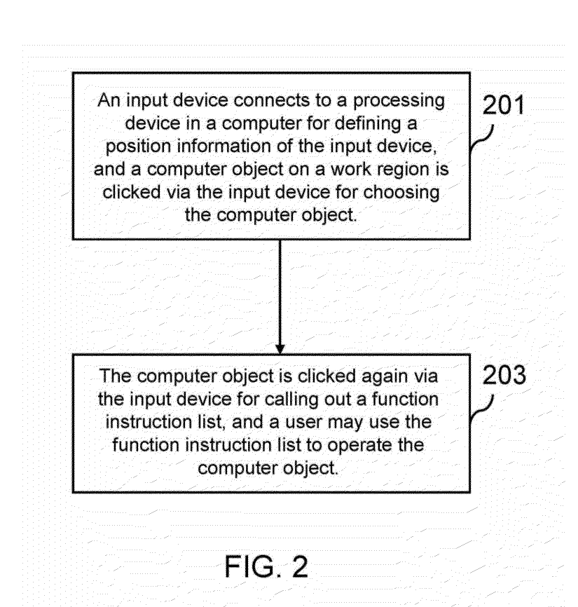

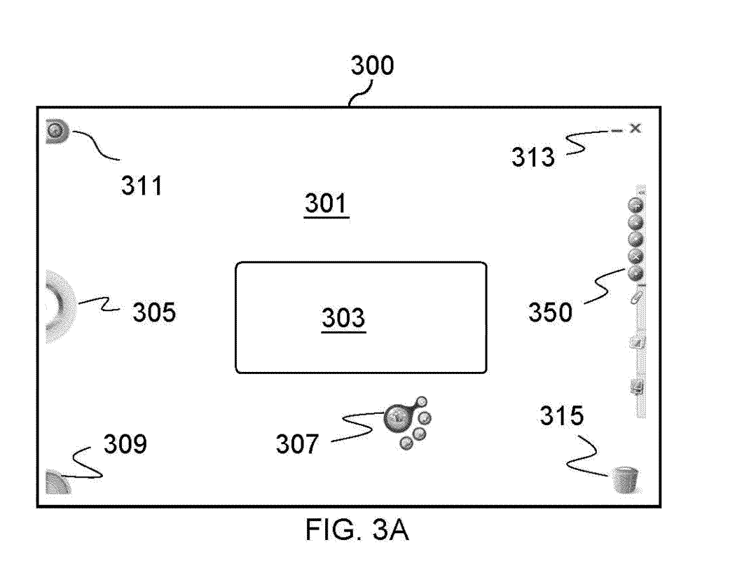

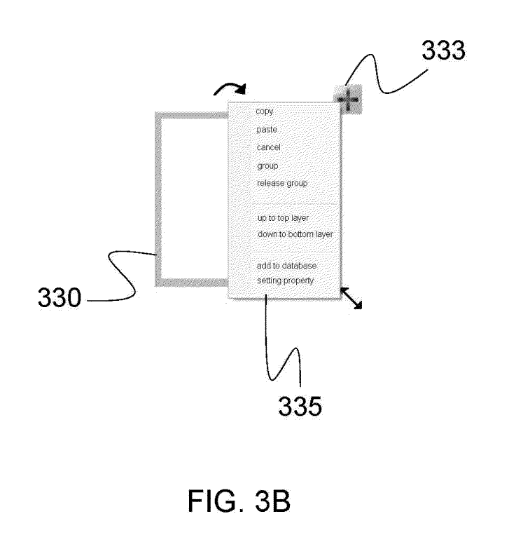

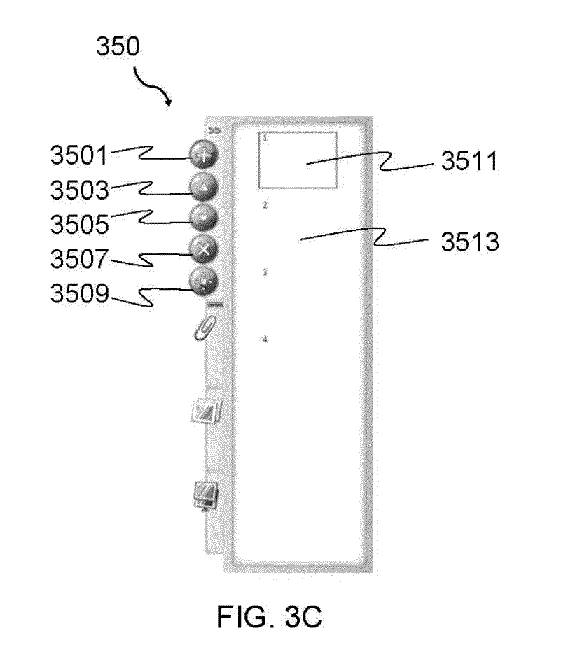

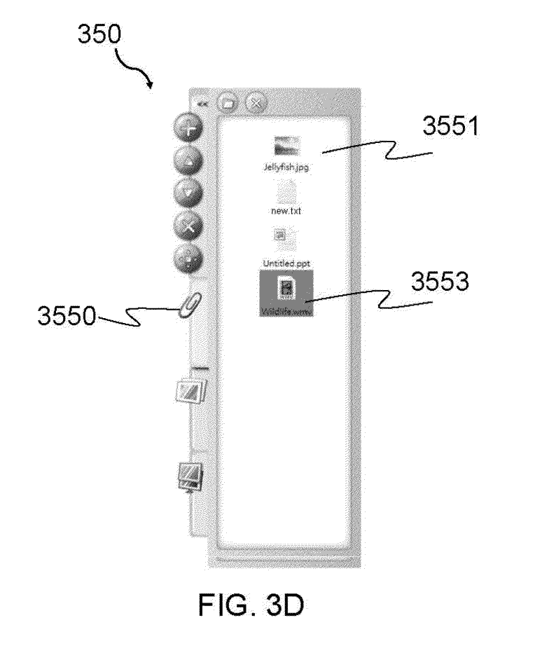

Subsequently, referring to FIG. 2, it illustrates a flow chart of an embodiment of a method of operating computer objects according to the present invention, and is described in detail by accompanying with the system shown in FIG. 1 and a schematic diagram of an embodiment of a computer program product according to the present invention shown in FIG. 3A.

An input device 130 connects to a processing device 110 in a computer 101 for defining a position information of the input device 130, and a computer object 303 which is chosen on a work region 301 of an operating interface 300 is clicked for choosing the computer object 303 via the input device 130 (Step 201). In this case, the work region 301 may be defined by a computer program product and be displayed on the operating interface 300.

In FIG. 1, a computer program product 123 of the present invention is installed in an operating system 121 and stored in a storage device 120 of the computer 101, and therefore, the computer program product 123 is run on the computer 101 via the processing device 110. Thus, the operating interface 300 shown in FIG. 3A is displayed on a displaying device 140. In an embodiment of the present invention, the computer program product 123 may be a computer program product of graphic and presentation. It's anticipated that the foregoing description related to the computer program product 123 only showing one function is utilized to describe briefly and clearly. It should not be limited in this.

The operating interface 300 of the computer program product 123 comprises a work region 301 and a plurality of instructions for users to show contents of their presentation or for users to make a graphical picture. In the work region 301, it may comprise computer objects 303. It's anticipated that only one computer object 303 is shown in the FIG. 3A for making the description and diagram more briefly and clearly, however, two or more computer objects may be comprised in the work region 301.

When a user operates the operating interface 300 via the input device 130, the processing device 110 will define a position of an inputting point is of the input device 130 automatically. In an embodiment, the input device 130 and the displaying device 140 is a touch panel device, and a user may touch and click the computer object 303 in the work region 301 of the operating interface 300 displayed in the touch panel device. Thus, the processing device 110 will define the computer object 303 becoming to a chosen state.

In another embodiment, the input device 130 is a mouse device and the displaying device 140 is a monitor. In this case, a user may use the mouse device to move a cursor shown in the operating interface 300 to the computer object 303 in the work region 301 and to click the computer object 303 for choosing. Moreover, the input device 140 may comprise a keyboard for users to choose the computer object 303 via the mouse device with some function buttons in the keyboard. For example, users may hold a Ctrl button in the keyboard and use the mouse to click the work region 301 for releasing the chosen state of computer objects which are not chosen in this moment.

Subsequently, the computer object 303 is clicked again via the input device 130 for calling out a function instruction list 305, and users may use the function instruction list 305 to operate the computer object 303 (Step 203).

In operating interface 300, it has a plurality of instructions for offering users to operate, and these instructions are briefly introduced herein. In FIG. 3A, the function instruction list 305 is set at an edge portion of the work region 301 in the operating interface 300. When users touch or move a cursor to the function instruction list 305 via the input device 130, the function instruction list 305 will extend and show further workable function instructions for the users to select and operate, such as actions of rotation, zoom in/zoom out or movement, but do not limit in these. In an embodiment, the function is instruction list 305 further has capable to rotation the list for users to select and operate the computer object 303 more instinctively. Moreover, the computer object 303 which is chosen may be dragged out of the work region 301 by the input device 130 for closing, making miniature or cancelling via the processing device 110.

Besides, each computer object which is chosen further may call out its exclusive dynamic function instruction list 307. Thus, users may use the function instruction list 305 or the exclusive dynamic function instruction list 307 of the computer object 303 depending on the user's practical requirements. In this case, the function of the exclusive dynamic function instruction list 307 may allow multiple computer objects in the work region 301 to be operated at the same time, and provide users more convenient.

The operating interface 300 may also comprise a palette 309 for users to select a requiring color for painting, and a status line 311 for users to select a requiring operating mode. In an embodiment, the status line 311 also has a function for expending selective items. In this case, when users touch or make a cursor to the status line 311 via the input device 130, the status line 311 will expend and show the workable operating modes for and the present operating mode for users to select. In some embodiments of the present invention, the operating mode may comprise painting mode, whiteboard mode, or presenting mode, but do not limit in these.

In addition, the operating interface 300 may also comprise a function button of minimize/close 313 set on the up right corner of the operating interface 300 for users to minimize a window of the computer program product 123 or close the computer program product 123. A function button of trash can 315 may offer users to cancel computer objects by choosing those computer objects and moving them to the trash can when those computer objects do not need any more. Moreover, the operating interface 300 further comprises multiple pages labeling function list 350, and the detailed functions are described in following.

Therefore, users may operate one or more computer objects, such as actions of rotation, zoom in/zoom out, movement, more instinctively via the method of operating computer objects according to the present invention.

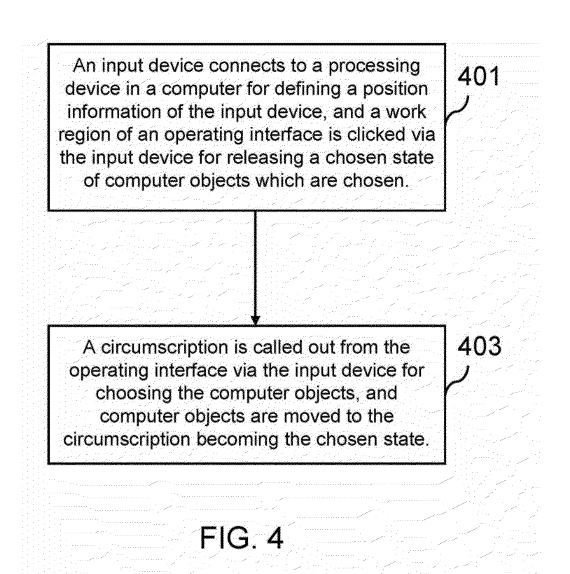

Referring to FIG. 4, it illustrates a flow chart of another embodiment of a method of operating computer objects according to the present invention. Similarly, it is described in detail by accompanying with the system shown in FIG. 1 and schematic diagrams of the embodiment of the computer program product according to the present invention shown in FIGS. 3A-3D. It's anticipated that the same portions of the method of operating computer objects shown in FIG. 2 will be not described again for briefly.

An input device 130 connects to a processing device 130 of a computer 101 for defining position information of the input device 130, and a work region 301 of an operating interface 300 is clicked via the input device for releasing a chosen state of computer objects 303 which are chosen (Step 401).

In an embodiment, the input device 130 is a touch panel device. When a user touch the touch panel device via his fingers, the processing device 110 will compute position information related to a touch point of the user's finger. Moreover, the user touches and click the work region 301 of the operating interface 300 and does not contact with any one computer object, and the is processing device 110 will list all of computer objects which are chosen with their states. Thus, the user may release the chosen state of those computer objects. In addition, in an embodiment, the input device 130 is a mouse device. When the user moves a cursor to click the work region 301 via the mouse device, all of the computer objects which are in chosen states will be released.

Subsequently, a circumscription 330 is called out from the operating interface 300 via the input device 130 for choosing the computer objects 303, and the computer objects 303 are moved to the circumscription 330 becoming the chosen state (Step 403).

Referring to FIG. 3B, users may call out a circumscription 330 in the work region 301 via a function instruction list 305, and the users may use the circumscription 330 to choose computer objects 303 in the work region 301. Thus, the computer objects 303 which are chosen into the circumscription 330 will become to a chosen state. In this case, the top right corner of the circumscription 330 further has a function button of circumscription 333. When a user touch the function button of circumscription 333 via the input device 130, the processing device 110 will display a function list of circumscription 335 for the user to operate some detailed functions of the circumscription 330.

In addition to the foregoing features, the computer program product 123 of the present invention may further have a multiple pages labeling function list 350 of the operating interface 300 for increasing operating ranges of the work region 301. Thus, users may operate the computer program product 123 more handily.

Referring to FIG. 3C, in an embodiment of the present invention, the multiple pages labeling function list 350 comprises some detailed function buttons, such as new 3501, previous page 3503, next page 3505, cancel 3507 and extend 3509. Similarly, users may touch the multiple pages labeling function list 350 for displaying the detailed states via the input device 130. When a user touches or moves a cursor to the multiple pages labeling function list 350, the multiple pages labeling function list 350 will display the used pages 3511, 3513 in the present moment. Moreover, the present used page 3511 will be labeled, and users may understand what the present used page shown in the work region 301 is immediately. Otherwise, the other existing used pages 3513 will be presented via a miniature picture, and the users may understand immediately how many used pages are for increasing conveniences of operation. When a user touch or move a cursor to the function button of new 3501, a new page will be added for providing the user to paint or do other operating actions. When numbers of the used pages are very large, the function buttons of previous page 3503 and next page 3505 will be offered for the user to find his required page more quickly. Moreover, the function button of cancel 3507 is offered for the user to cancel some pages that he would like to cancel, and the function button of extend 3509 is offered for the user to expend the operating ranges of the present used page 3511. Thus, the user may add the operating ranges in the same page for painting or do other actions continuously without changing or building up a new page.

Furthermore, the computer program product 123 of the present invention has a function of attachment via the multiple pages labeling function list 350 in the operating interface 300. Referring to FIG. 3D, when users touch or move a cursor to the label of attachment 3350 via the input device 130, an attachment list 3551 will display. In the attachment list 3551, a ground color of is chosen attachment 3553 may be marked for obviously to the users. In an embodiment, the computer program product 134 of the present invention further is capable to support a plurality of types of data, such as .jpg, .txt, .ppt, .wmv, and the like.

Therefore, users may add data into the computer program product 123 via the function of attachment 3550, and the processing device 110 will execute and open those different-type data. Thus, in presentations or teachings, users may only use the computer program product 123 of the present invention to open various data without using other computer program products stored in the storage device 120 to open those data. Without complicacy process to switch the different-type data by the operating system 121, users could operate computer objects with most instinctive ways.

Subsequently, in an embodiment of the present invention, the computer program product 123 may also connect to internet by a browser built-in the computer program product 123. In another embodiment of the present invention, the computer program product 123 may further support various formats of video/audio to play. Thus, users may play video or audio data in the presentation directly for increasing variety of the presentation and teachings.

In certain embodiments of the present invention, the displaying device 140 may be a large-size monitor. In this case, the work region 301 further may be divided into a plurality of small regions for multiple people to operate at each small region. For example, during a teaching, a teacher may make multiple students to operate in different regions, and the teacher himself operates one small region thereof for increasing interactive effects in the is teaching.

As mentioned-above, users may employ the method for operating computer objects and the computer program product according to the present invention more instinctively in a meeting for presenting or teaching. Furthermore, the computer program product including the foregoing functions also may increase variety and interactive effects of the contents of the presentation and teachings.

It will be understood that the above descriptions of embodiments are given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A method of operating computer objects utilized to an operating interface in a computer, wherein the operating interface comprises defining a work region, at least one function instruction list and a plurality of computer objects, and parts of the computer objects are chosen, the steps of the method comprising:
connecting an input device to a processing device in the computer for defining a position information of said input device, and clicking one computer object on the work region of the operating interface via said input device for choosing the computer object; and
clicking the computer object which is chosen and calling out one function instruction list of the computer object via said input device for operating the computer object, wherein the function instruction list comprises actions of rotation, zoom in/zoom out, movement.

2. The method of the claim 1, further comprising the step: dragging the computer object which is chosen out of the work region for closing, making miniature or canceling the computer object via the processing device.

3. The method of the claim 2, wherein said input device comprises a touch panel device and the touch panel device includes at least two touch points for operating the touch panel device by a user via gestures.

4. The method of the claim 1, wherein said input device comprises a touch panel device and the touch panel device includes at least two touch points for operating the touch panel device by a user via gestures.

5. The method of the claim 1, wherein said input device comprises a mouse device.

6. A computer program product for utilizing to graphic and presentation, comprising software code portions for performing the steps of claim 1 when said product is run on a computer.

7. A method of operating computer objects utilized to an operating interface in a computer, wherein the operating interface comprises defining a work region, at least one function instruction list and a plurality of computer objects, and parts of the computer objects are chosen, the steps of the method comprising:
connecting an input device to a processing device in the computer for defining a position information of said input device, and clicking the work region of the operating interface via said input device for releasing a chosen state of the computer objects on the work region; and
calling out a circumscription in the operating interface and using the circumscription to choose the computer objects, wherein the computer objects are moved into the circumscription becoming to a chosen state, and operated via the function instruction list by said input device.

8. The method of claim 7, wherein said input device comprises a mouse device or a touch panel device.

9. The method of claim 7, further comprising the step: dragging the computer objects which are chosen out of the work region for closing, making miniature or canceling the computer object via the processing device.

10. The method of claim 9, wherein said input device comprises a mouse device or a touch panel device.

11. The method of claim 7, wherein the step of clicking the work region of the operating interface via said input device further comprises:
listing all of the computer objects in the work region and states of the computer objects.

12. The method of claim 11, wherein said input device comprises a mouse device or a touch panel device.

13. A computer program product for utilizing to graphic and presentation, comprising software code portions for performing the steps of claim 7 when said product is run on a computer.
